(19) United States
(12) Patent Application Publication
(10) Pub. No.: US 2007/0128073 A1
(43) Pub. Date: Jun. 7, 2007

(54) Device for automatic preparation of blood smears on plates

(75) Inventor: Frank M. Tappen, Plantation, FL (US)

Correspondence Address: BECKMAN COULTER, INC., P.O. BOX 169015, MAIL CODE 32-A02, MIAMI, FL, 33116-9015, US

(73) Assignee: Beckman Coulter, Inc., Fullerton, CA (US)

(21) Appl. No.: 11/296,249

(22) Filed: Dec. 7, 2005

(51) Int. Cl. G01N 35/00

(52) U.S. Cl. 422/65

(57) ABSTRACT

A device for automatic preparation of blood smears on plates comprises a spreading unit that spreads a drop of sample blood on individual plates in order to produce a regularly distributed blood smear on each plate. After the blood smear is dried, the plate is passed to a fixative bath filled with a fixative agent. Following submersion of the dried blood in the fixative agent, the plate is then removed from the fixative bath and delivered to a revolving stainer. The revolving stainer processes the plate and colors the blood smear on the plate. The revolving stainer is separate from the fixative bath and moves independent of the fixative bath. After the plate is processed in the stainer, the plate having a colored blood smear is unloaded from the device. A robotic pick and place is used to move the plate between the conveyor, fixative bath and revolving stainer.

### BACKGROUND

The invention relates to the field of hematological analyses, and more specifically to the preparation of blood smears on plates.

In this particular field, it is known to deposit a drop of a blood sample on a plate (also referred to herein as a “slide”), such as a glass plate for analysis under a microscope, and to spread this drop on the plate in order to produce what is known as a blood smear. The latter is then dried, and then colored by at least one appropriate reagent, in order to permit subsequent analysis under the microscope. In fact, analysis of plates of this type makes it possible to determine the composition of the blood sample concerned, which is of great importance for the diagnosis of specific pathologies.

Blood smears of this type can be prepared by automated devices, which, on the basis of a stock of new plates, carry out a multiplicity of operations of depositing and spreading of blood on plates and miscellaneous subsequent processing operations such as drying and coloring. The plates thus processed are then collected in appropriate containers, and sent to a laboratory for analysis.

Many commercially available devices of this type include a coloring unit (also referred to herein as a “stainer”). After a blood smear is deposited on a plate and dried, the plate it is then delivered to the coloring unit where color is added to the blood smear. Many of these coloring units revolve such that each plate positioned on the coloring unit is processed from a starting position to an ending position. In between the starting position and the ending position, each plate is subjected to a plurality of processing stations operable to add color to the blood smear on the plate. In one embodiment, the revolving coloring unit is a rotatable carousel comprising a plurality of wells with each of the wells designed to hold one of the plates. An example of such a coloring unit is disclosed in U.S. Pat. No. 6,319,470, which is incorporated herein by reference in its entirety.

Typically, a fixative bath is the first processing station encountered by a plate on such a revolving coloring unit. The fixative bath may be provided by filling the well holding the plate with a fixative agent, such as pure methanol. The fixative agent is provided to assure the blood cells on the plate are “fixed” and will remain free of water-induced defects during subsequent processing. In some situations, a stain may be included with the fixative agent in the first processing station.

After the plate is subjected to the fixative bath, the carousel is rotated in an indexing fashion to another position where the fixative agent is removed, and a second fluid is placed in the well holding the plate. This process is repeated for various subsequent staining stages, as the well holding the plate is rotated through a complete revolution by the carousel. The later stages of the staining process typically involve water-based solutions. The final step of the process is to drain the well, remove the stained slide, and place a new unstained slide in the well to repeat the process.

The foregoing process works well for a first set of plates that move through the process starting in completely dry wells. However, it has been noticed that a problem occurs when the wells are reused to move additional plates through the process before the wells are thoroughly dried. In particular, after a well moves a first plate through the process, a small amount of water remains in the well. If the well is reused before it dries to move a subsequent plate through the process, the small amount of water in the well adulterates the pure methanol fixative agent placed in the well. The result following processing is that red blood cells on the subsequent slide appear to have a halo or bright ring in their center when viewed under a microscope. This halo makes it difficult to observe the internal features of the cell and makes analysis of the sample difficult and possibly inaccurate.

Accordingly, it would be desirable to provide a device for automatic preparation of blood smears on plates that includes a revolving stainer, but avoids the above-described problem.

### SUMMARY

A device for automatic preparation of blood smears on plates comprises a storage unit that stores new plates in a stack. An extractor unit is used to extract plates from the stack and place the plates on a conveyor one at a time. As the plates pass along the conveyor, a depositing unit deposits a drop of blood on each plate extracted from the stack. A spreading unit spreads the drop of blood on each plate in order to produce a regularly distributed blood smear on the plate. A drying unit dries the blood smear on the plate. After the blood smear is dried, the plate is passed to a fixative bath. The fixative bath is filled with a fixative agent, and the blood smear is submerged in the fixative agent when it is placed in the fixative bath. The plate is then removed from the fixative bath and delivered to a revolving stainer that colors the blood smear on the plate. The revolving stainer is separate from the fixative bath and moves independent of the fixative bath. After the plate is processed in the stainer, the plate having a colored blood smear is unloaded from the device. A robotic pick and place is used to move the plate between the conveyor, fixative bath and revolving stainer.

### BRIEF DESCRIPTION OF THE DRAWINGS

FIG. 1 is a schematic perspective view of a device according to the invention;

FIG. 2 is a plan view of the device in FIG. 1;

FIG. 3 is a plan view of the storage unit and the extractor unit;

FIG. 4 is an illustration of the method of action of the extractor unit;

FIG. 5 shows a sensor which is part of the depositing unit, depositing a drop of blood on a plate which is supported by a carriage;

FIG. 6 shows an optical transmission measuring unit, which is associated with the spreading unit;

FIG. 7 shows a tool of the spreading unit;

FIG. 8 shows a tilter of the drying and tilting unit;

FIG. 9 is a view in vertical cross-section of the coloring unit;

FIG. 10 shows schematically the various paths of the handling bracket;

FIG. 11 is a schematic elevational view of the handling bracket; and

FIG. 12 is a schematic plan view of the handling bracket and a moveable fixative bath.

### DESCRIPTION

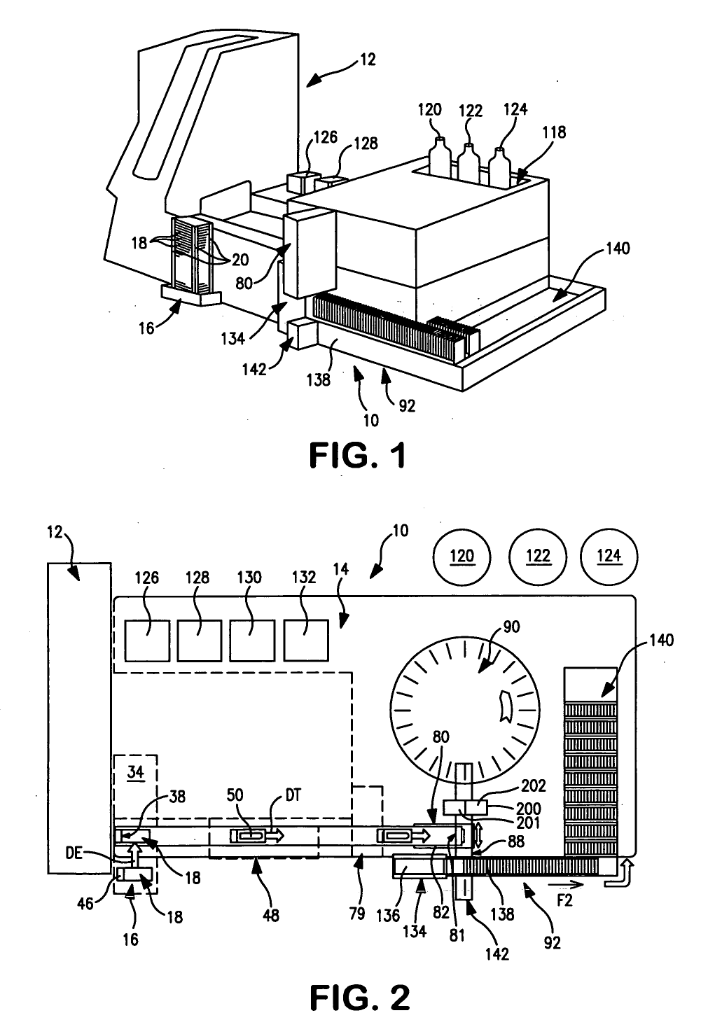

Reference is made firstly to FIGS. 1 and 2, which represent a device 10 for preparation of blood smears according to the invention. In this example, this device is combined with a device 12, which produces haemograms in parallel.

The device 10 comprises a rectangular base plate 14, which supports various units, and a unit 16 for storage of new plates 18. These plates are rectangular glass plates, which are disposed horizontally, and are superimposed in a vertical stack, and are maintained between columns 20 (FIG. 1). This arrangement permits re-supply during operation, since the operator simply has to place new plates on top of the stack.

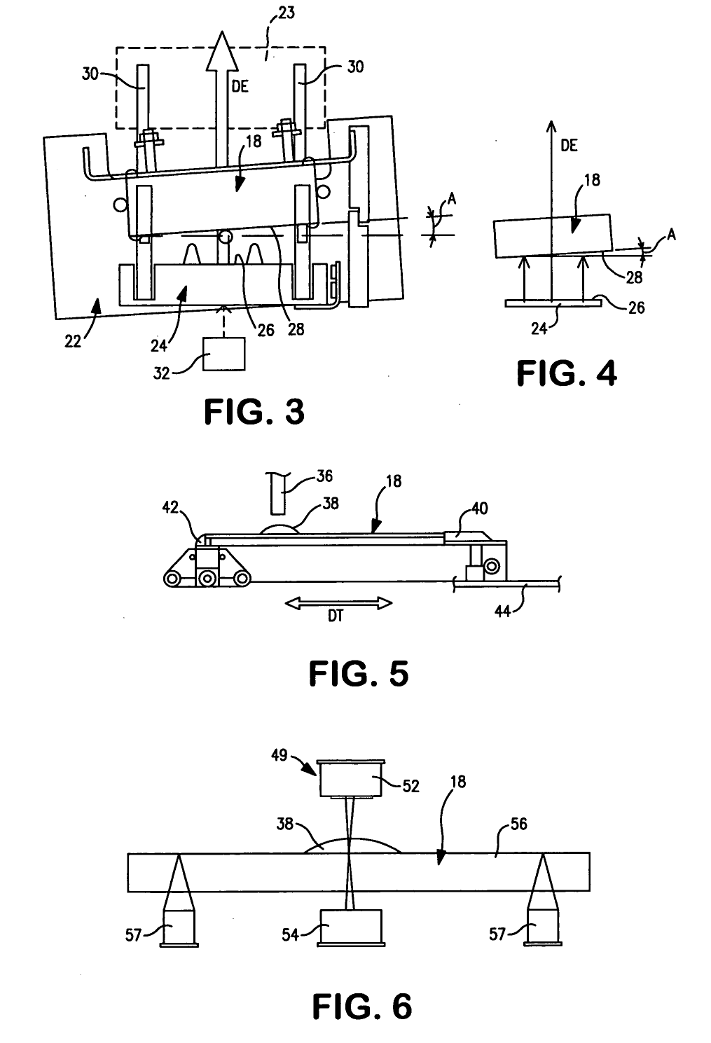

The device according to the invention additionally comprises an extractor unit 22 (FIG. 3), which is provided in order to extract the plate which is disposed at the base of the stack, in order to bring it onto a carriage 23 (shown schematically in FIG. 3), which then conveys the plate towards other units contained in the device according to the invention. The extractor unit 22 comprises a thruster 24, which can be displaced in a direction of extraction DE, as shown by an arrow in FIGS. 2, 3 and 4. The thruster 24 is in the form of a horizontal blade, the thickness of which is smaller than that of the plate to be extracted. This blade comprises a longitudinal edge 26, which is also known as a front edge, which can act on a longitudinal edge 28 of the plate 18.

The thruster 24 is guided in translation by rods 30 (FIG. 3), and its displacement is advantageously obtained by an assembly 32, shown schematically in FIG. 3, which comprises a step motor and a ballscrew.

Once the plate has been placed on the carriage 23, it is at the level of the following unit of the installation, i.e. the depositing unit 34 (FIG. 2). At the unit 34, there is provided a sensor 36 (see FIG. 5) which, in the example, is part of the device 12, but which, as a variant, can be part of the device 10 itself. This sensor is moved by displacement means (not shown), and is designed to collect blood from a sample tube (not shown), and then to deposit a drop of blood 38 (FIGS. 2 and 5) on the new plate 18 which has just been deposited on the carriage 23. On the carriage 23, the plate 18 is maintained between a fixed stop 40 and a tilting gripper 42, which is also known as a clip.

The drop of blood is deposited by means of the sensor 36, in a pre-determined position on the plate, which is kept secured, the carriage 23 being immobilized in translation. The volume of the drop of blood is pre-determined, and can be adjusted by the user.

The carriage 23 can be displaced in horizontal translation, according to a direction of translation DT (FIGS. 2 and 5) which is perpendicular to the direction of extraction DE. The displacement in translation of the carriage is carried out by a conveyor with appropriate drive means, for example by a belt 44 driven by rollers, which is shown schematically in FIG. 5.

As can be seen in FIG. 2, the plate 18 has a reserved area 46 with a generally rectangular shape, which is provided at one end of the plate 18, and the drop of blood 38 is deposited on the plate, in the vicinity of this reserved area.

The conveyor then displace the carriage 23 towards a unit 48, which is known as the spreading unit 48 (FIG. 2, 6 and 7), and is provided in order to spread the drop of blood, and thus form a smear 50. The spreading unit 48 is disposed on the path of the carriage 23 which provides transfer of the plate.

The spreading unit 48 (FIG. 6) comprises a measuring unit 49 which can measure the optical transmission of the drop of blood 38 deposited on the plate. This measuring unit comprises an electro-luminescent diode 52 and a photo-diode 54, which are disposed on both sides of the plate 18, in the position of the drop of blood 38. In this case, the electro-luminescent diode 52 is disposed on the same side as the upper surface 56 of the plate, which receives the drop of blood. In the example, the electro-luminescent diode emits at 560 nm.

There is then deduced a measured value of the optical transmission (TO), which depends on the thickness of the drop and its content. It has been shown by tests that this measurement is inversely proportional to the haematocrit reading of the blood concerned. On the basis of the measurement thus obtained, the spreading speed of the blood, and thus the thickness of the smear, is adjusted.

Thus, a blood sample which contains many cells, and therefore has a high haematocrit reading, provides a lower TO measurement, thus generating a high spreading speed. Conversely, a sample which has a low hematocrit reading provides a high TO measurement, and a low spreading speed.

On the basis of this measurement, it is thus possible to control the spreading speed accurately, and to obtain regular distribution of the cells on the plate, irrespective of the quantity of cells present in the blood sample.

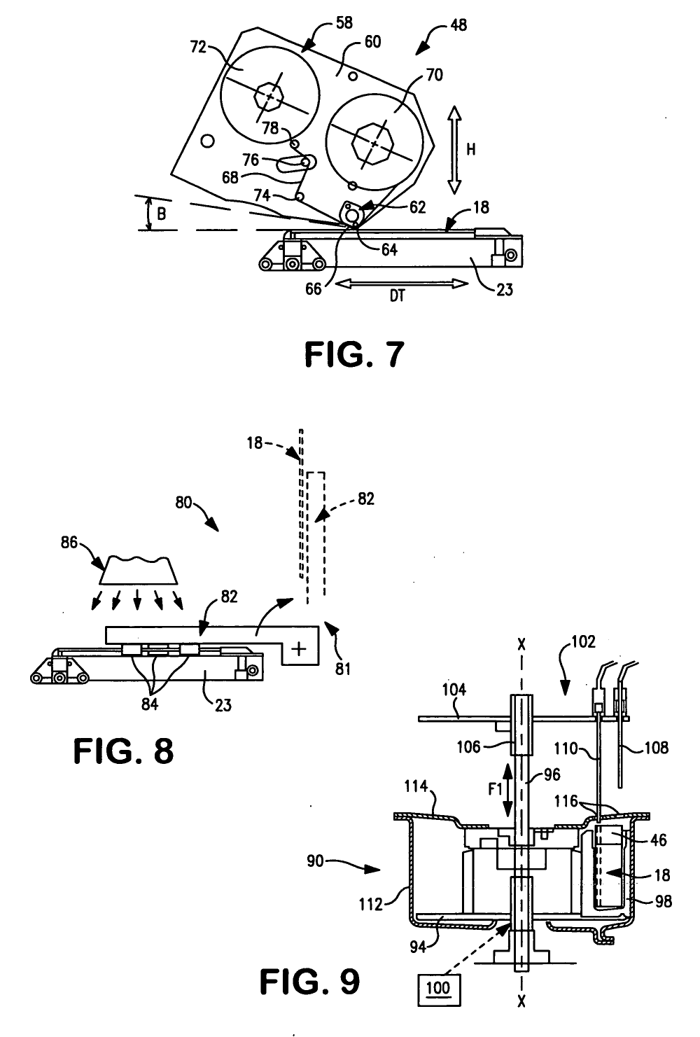

When this measurement has been carried out, the spreading is carried out at the spreading unit 48 by a tool 58, which is represented in FIG. 7. The tool 58 comprises a fixed support 60, which supports a counter-block 62, which is designed to carry out the spreading by relative displacement between the counter-block 62 and the plate 18, which is supported by the carriage 23. In the example, it is the displacement of the plate 18 by the carriage 23, in the direction of translation DT, which gives rise to the spreading. The counter-block 62 remains in a fixed position, except that the height of the support 60 can be regulated as shown by the arrow H. In addition, as can be seen, the counter-block 62 has a ridge 64 which is connected to an edge 66, which forms an adjustable angle B with the upper surface 56 of the plate. This adjustable angle B can be modified as required, in order to adjust the thickness of the smear. In general, the angle B is approximately 30 degrees.

As can be seen in FIG. 7, the counter-block 62 does not come directly into contact with the drop of blood. For this purpose, the invention comprises a flexible strip 68 made of plastics material, for example of polyethylene, which is stretched around the counter-block 62 such as to cover completely the ridge 64 and the edge 66 of the counter-block. The tool 60 comprises means for winding and unwinding the strip 68. These means comprise a first bobbin 70 (unwinding bobbin), from which the new strip is unwound, and a second bobbin 72 (winding bobbin), onto which the strip which is soiled by the blood is wound. Between its passage around the counter-block and winding around the bobbin 72, the strip passes around return rollers 74, 76 and 78.

The part of the strip which is in contact with the blood is displaced between two successive spreading operations, such as to provide a blank portion of strip for the following smear, and thus to prevent any risk of contamination.

Advantageously, the bobbins 70 and 72 are contained in a case, which must be changed when the strip is completely used up.

The plate 18 which supports the smear 50 is then transferred, again by the carriage 23, to a marking unit 79 (FIG. 2), which comprises a marking head, which for example can consist of a print head of the needle matrix type, with an ink ribbon. The plate is marked on the reserve area 46 previously described. This area must be ground or pre-painted, in order to allow the printing inks to adhere well. The marking can also be carried out in other manners, for example by means of a ribbon or other printing means disposed in the position of the spreading unit previously described.

When the marking has been carried out, the carriage 23 transfers the plate 18 to a unit 80, which is a drying and tilting unit (FIGS. 1 and 8). The carriage deposits the plate at the unit 80, and the latter is received by a tilter 82, which allows the empty carriage to return to the depositing unit in order to receive a subsequent plate.

The plate is supported by the tilter 82, by means of rollers 84, and which are made of polymer. The plate is then subjected to a flow of warm air, maintained at about 40° C., which is conveyed by a forced air heater 86. The tilter 82 (FIGS. 2 and 8) then tilts the plate by 90°, in order to bring it into a vertical position (shown in broken outline in FIG. 8), in which the reserved area 46 of the plate is disposed at the top.

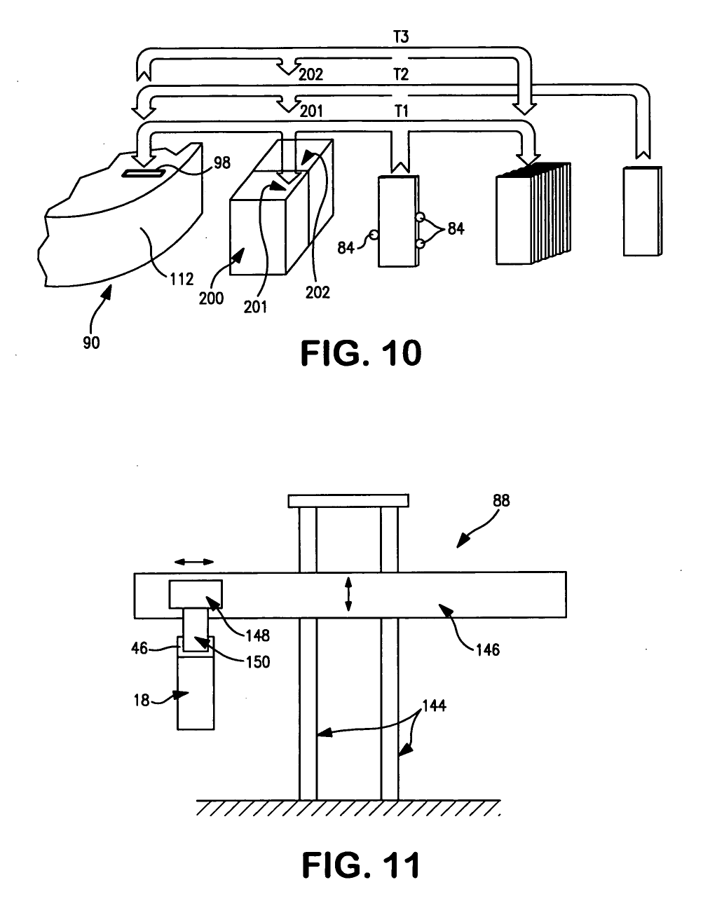

The plate thus brought into a vertical position can then be collected by a handling bracket 88 (FIG. 2), which is described in detail hereinafter with reference to FIGS. 10 and 11. The handling bracket may be a robotic pick-and-place device as is known in the art for moving structures from one location to another. In particular, this handling bracket makes it possible to transfer the plate 18 from a loading position 81 (FIG. 2 and 8) to a fixative bath 200, a coloring unit 90, and/or an output unit 92.

As shown in FIG. 11, the fixative bath 200 generally comprises a dedicated fixative well 201 designed and dimensioned to receive at least one plate 18. The fixative well 201 is typically deep enough such that the substantial part of a plate will rest in the well below the top rim of the well. The fixative well 201 is substantially filled with a fixative agent, such as pure methanol. The fixative agent is provided to assure the blood cells on the plate are “fixed” and will remain free of water-induced defects during subsequent processing. When a plate with a dried blood smear is placed in the fixative well, the dried blood smear is bathed in the fixative agent. After bathing in the fixative agent, the plate is ready for transfer to the coloring unit 90.

The coloring unit 90 (FIG. 9) comprises a revolving turntable 94 (also referred to herein as a “carousel”). The revolving turntable is mounted to rotate around a shaft 96 with a vertical axis XX. This turntable supports a plurality of receptacles 98 known as “wells”, which are distributed circumferentially, and of which there are thirty two in the example shown. These wells are disposed vertically, and have dimensions which are adapted to those of the plates. The turntable 94 is connected to a drive means 100, which are shown schematically in FIG. 9, and can rotate the turntable in successive increments, such as to bring the wells in sequence into different positions. Thus, the turntable can carry out angular rotation sequentially from well to well, for example every 30 seconds. Initially, an empty well is disposed at right-angles to the bracket 88, in order to receive a plate.

The plate then undergoes at least one operation in each sequential position of the turntable.

For this purpose, the coloring unit additionally comprises filling and emptying means 102, which comprise a support 104, which can be displaced in vertical translation parallel to the axis of rotation of the turntable. In the example, the support 104 comprises a drum 106, which can slide along the shaft 96, as shown by the arrow F1. The support 104 supports two plunger needles, which are disposed vertically, i.e. an injection needle 108 and an emptying needle 110. The support 104 can be displaced between a high position, in which the needles are extracted from the well 98 (as shown as a solid line in FIG. 9), and a low position in which the needles are plunged into the well. The position of the needles determines the incubation time, such that the needles are displaced in accordance with the coloring conventions selected.

As can be seen in FIG. 9, in the position in which the plate 18 is accommodated in the well 98, the reserved area 46 of the plate, which bears the means of identification, is disposed at the top, such that it is outside the fluid which is contained in the well.

The coloring unit additionally comprises a closed enclosure, comprising a base 112 and a cover 114, which surrounds completely the turntable 94 and the wells 98 which it contains, such as to prevent migration of toxic vapors derived from the reagents or solvents which are injected into the well. The cover 114 contains holes 116, in order to permit passage of the needles.

The plates which are installed in the wells are immersed in succession in dyes and other treatment fluids, in order to carry out one of the coloring operations necessary in order to identify a plate, according to the known methods of MAY-GRUNWALD, GIEMSA, WRIGHT & WRIGHT GIEMSA.

The device 10 comprises a recess 118 (FIG. 1) in order to accommodate bottles containing various fluids which can be injected into the wells, then emptied.

In the example, a bottle 120 is provided in order to contain a solvent (in this case methanol), as well as two bottles 122 and 124 to contain respectively two different dyes.

It should be noted that the device 12, with which the device 10 according to the invention is combined, comprises recesses to accommodate other reagents 126, 128, 130 and 132 (FIG. 2).

After a complete rotation, the plate 18, which has thus been processed, returns to its original position (i.e., the load/unload position of the stainer). In this position the plate 18 is ready to be transferred to the dry well of the output unit 92.

In one embodiment, the plate is transferred to a dry well 202 before it is transferred to the output unit. The dry well 202 may be attached to the fixative well in the fixative bath 200. Like the fixative well 201, the dry well 202 is typically deep enough such that the substantial part of a plate will rest in the well below the top rim of the well. The dry well 202 is separated from the fixative well 201 by a dividing wall 203. The dry well includes no reagent and is generally used as a holding tank for plates removed from the coloring unit 90 and awaiting delivery to the output unit 92. After a short period in the dry well 202, the plate 18 is next transferred to the output unit 92.

The output unit 92 comprises a receptacle 134 (FIGS. 1 and 2) which can accommodate empty stacked baskets 136. These baskets are then displaced one by one in a passage 138 in the direction of the arrow F2 (FIGS. 1 and 2). In the example, each of the baskets contains twenty recesses, which can each accommodate a plate in a vertical position, which has been supplied by the handling bracket. A mechanical feed device (not shown) makes it possible to feed the baskets in successive increments, in order to position each recess of a basket in succession beneath the handling bracket, and on each occasion to receive a pre-treated plate. When the baskets have been filled, they are stored in a storage area 140, before being retrieved by the operator.

In addition, the device 10 comprises a receptacle 142 for storage of plates which are spread manually, and need to be colored. In fact, in some cases, it is necessary to color plates which are already provided with blood which has been smeared manually. This receptacle 142 is also disposed at right-angles relative to the bracket, which thus makes it possible to collect a plate from the receptacle 142, in order to bring it directly to the coloring turntable. When the plate has been colored, it is displaced, and brought into a basket.

FIG. 10 shows schematically various exemplary possibilities which are provided by the handling bracket, i.e.: path T1, in order to bring a plate which is provided with a smear to the fixative bath 201 and then to the coloring turntable 90, or to a basket in the storage area, depending on whether or not a fixative agent and coloring is required for this plate. It also makes it possible to travel a path T2, in order, as previously described, to bring a plate which has been spread outside the receptacle 142, to the fixative bath 201 and coloring platform 90. It is also possible to travel a path T3, in order to displace a plate from the coloring platform 90, to the dry well 202, and then to a basket in the storage area.

Reference is now made to FIG. 11, in order to describe the general structure of the bracket 88. The latter comprises a fixed support 144, which consists of two vertical columns which form guide means, a horizontal beam 146, which can be displaced vertically relative to the fixed support, a slide 148, which can be displaced in translation along the beam, and a controlled gripper 150, which can grasp a plate and then release it, in order to displace it from one unit to another.

Appropriate drive means (not shown) make it possible to displace the beam 146 and the slide 148, such that the gripper 150 can occupy different positions in a vertical plane. The gripper 150 can be actuated by any appropriate means, for example by an electromagnet. It should be noted that the gripper acts on the reserved area 46 of the plate.

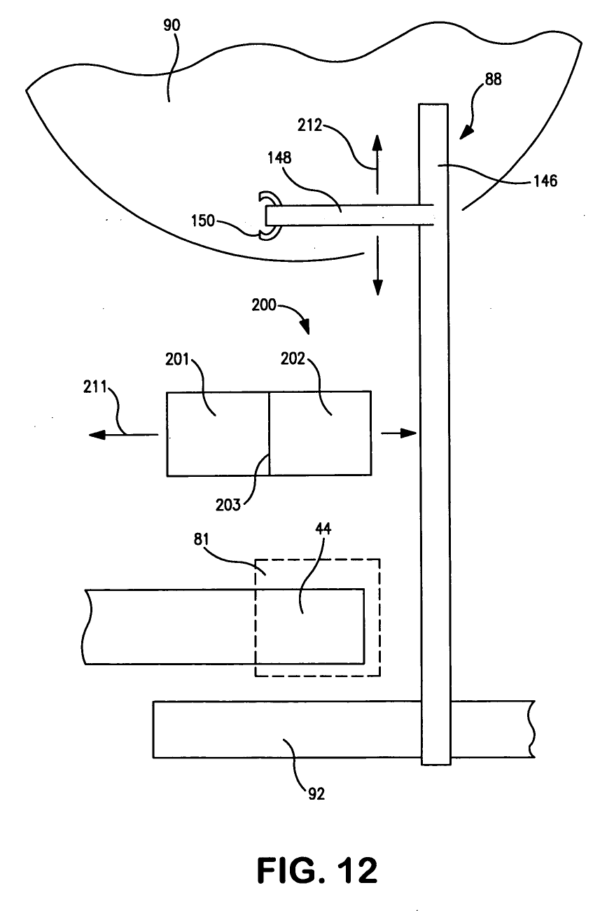

With reference to FIG. 12, in one alternative embodiment the fixative bath 200 comprises both the fixative well 201 and the dry well 202. In this embodiment, the fixative bath 200 is moveable along a first axis 211, which is perpendicular to a second axis 212 along which the slide 148 moves when moving in a horizontal direction. Because the fixative bath 200 is moveable, the fixative well 201 may be placed under the path of the slide 148 and associated gripper 150 when a plate is being moved from the loading position 81 to the fixative well 201 of the fixative bath 200 and from the fixative well 201 to the revolving stainer 90. Then, when plates are moved in the opposite direction, i.e., from the stainer 90 to the dry well 202 and from the dry well to the output unit 92, the fixative bath is shifted along the first axis 211 such that the dry well 202 is positioned under the path of the slide. Because the fixative well 201 and dry well 202 may be moved in this fashion, the gripper 150 can easily pick up and drop off plates in their proper position.

Thus, the above-described device is designed such that the fixative well never needs to be rinsed with water or an aqueous solution. When the fixative agent needs to be replaced, the old fixative agent is drained from the well and it is simply refilled with a new fixative agent. Accordingly, water never enters the fixative bath, and the problem of water contamination of the fixative agent is avoided.

Although the present invention has been described with respect to certain preferred embodiments, it will be appreciated by those of skill in the art that other implementations and adaptations are possible. For example, in one alternative embodiment, the pick-and-place device includes two grippers. A first gripper used to transport plates between the fixative bath and the conveyor and/or output unit. A second second gripper used to transport plates between the rotatable stainer and the fixative bath. In another alternative embodiment, two pick-and-place devices are utilized. The first pick-and-place device is used to transport plates between the unloading position, the fixative well, and the revolving stainer. The second pick-and-place device is used to transport plates between the revolving stainer, the dry well, and the output unit. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A device for automatic preparation of plates with blood smears, the device comprising:
a) a conveyor operable to move the plates with blood smears;
b) a fixative bath designed to receive the plates from the conveyor; and
c) a revolving stainer designed to receive the plates from the fixative bath and stain the blood smears on the plates, the stainer operable to move separate from the fixative bath.

2. The device of claim 1 further comprising a pick and place operable to move the plates from the conveyor to the fixative bath.

3. The device of claim 1 further comprising a pick and place operable to move the plates from the fixative bath the stainer.

4. The device of claim 3 wherein the pick and place comprises a first gripper operable to move plates between the conveyor and the fixative bath and a second gripper operable to move plates between the fixative bath and the stainer.

5. The device of claim 1 wherein the conveyor is a moving belt.

6. The device of claim 1 wherein the revolving stainer comprises a rotatable carousel.

7. The device of claim 1 wherein the fixative bath comprises a fixative well.

8. The device of claim 7 further comprising an intermediate dry well adjacent to the fixative well, wherein the intermediate dry well is designed to receive the plates from the stainer.

9. A method for automatically preparing a plate with a blood smear, the method comprising:
a) moving the plate with a blood smears into a loading position;
b) moving the plate from the loading position to a fixative bath;
c) moving the plate from the fixative bath to a revolving stainer;
d) processing the plate in the revolving stainer; and
e) removing the plate from the revolving stainer.

10. The method of claim 9 wherein a pick and place is used to move the plate from the conveyor to the fixative bath.

11. The method of claim 9 wherein a pick and place is used to move the plate from the fixative bath the stainer.

12. The method of claim 9 wherein the revolving stainer comprises a rotatable carousel.

13. The method of claim 9 further comprising the step of repeating steps a) through e) for an additional plate following the step of removing the plate from the revolving stainer.

14. The method of claim 9 wherein step e) comprises removing the plate from the revolving stainer to a dry well.

15. The method of claim 14 further comprising the step of removing the plate from the dry well.

16. A device for automatic preparation of blood smears on plates, comprising:
a) a storage unit operable to store new plates in a stack;
b) a extractor unit operable to extract a plate from the stack;
c) a depositing unit operable to deposit a drop of blood on a plate extracted from the stack;
d) a spreading unit operable to spread the drop of blood in order to produce a regularly distributed blood smear on the plate;
e) a drying unit operable to dry the blood smear on the plate;
f) a fixative bath operable to submerge the blood smear on the plate in a fixative agent;
g) a revolving stainer operable to color the blood smear on the plate, wherein the revolving stainer is separate from the fixative bath; and
h) an output unit operable to unload the plate having a colored blood smear.

17. The device of claim 16 wherein the revolving stainer comprises a revolving carousel.

18. The device of claim 16 further comprising a pick and place operable to move the plate between the fixative bath and the revolving stainer.

19. The device of claim 16 further comprising a conveyor operable to transfer the plate along a predetermined path.

20. The device of claim 19 wherein the fixative bath is positioned between the conveyor and the revolving stainer.
